(19) United States
(12) Patent Application Publication
(10) Pub. No.: US 2005/0075023 A1
(43) Pub. Date: Apr. 7, 2005

(54) Non-slip materials and articles and methods of making thereof

(76) Inventor: Yusuf Kemal Ayata, Besiiktas (TR)

Correspondence Address: NEEDLE & ROSENBERG, P.C., SUITE 1000, 999 PEACHTREE STREET, ATLANTA, GA, 30309-3915, US

(21) Appl. No.: 10/679,139

(22) Filed: Oct. 3, 2003

(51) Int. Cl. B32B 27/04; B32B 3/00; B32B 5/02; B32B 27/12; B32B 29/02

(52) U.S. Cl. 442/103; 442/295; 442/286; 442/293; 442/300; 442/394; 442/399; 442/412

(57) ABSTRACT

Described herein are materials for producing non-slip articles. Also described herein are methods for producing the materials and articles containing the non-slip material.

### FIELD OF THE INVENTION

Described herein are materials for producing non-slip articles. Also described herein are methods for producing the materials and articles containing the non-slip material. An example of an article described herein includes, but is not limited to, a food tray.

### BACKGROUND OF THE INVENTION

Articles such as food service trays are made from materials such as stainless steel and a variety of polymers. At times, it is preferred that the trays are non-slip. A non slip surface reduces or eliminates slipping of food dishes, glasses, and other items carried by wait staff. Non-slip surfaces make it easier for wait staff to maneuver without spilling or dropping items on the tray. Such accidents can ruin clothes, furniture, carpets, etc., which are highly unpleasant for the customers, guests, and wait staff.

One common method for producing a non-slip surface is to apply a polyurethane-based foil or varnish to the tray surface. This material has some disadvantages in that it is not stain resistant. Additionally, when the tray surface is wet, it becomes highly slippery, which negates the purpose for which it was applied. Some users cover the tray with a fabric napkin, which increases the non-slip nature by absorbing water. However, coffee, effervescent beverages, fruit juices, vinegar, and oil will stain the tray, particularly on the non-slip surface. These liquids usually have acidic or basic characteristics that will mar the polyurethane foil on the surface of the tray. These stains cannot be removed by any cleaning method or material.

Additionally, the polyurethane material is not UV or dishwasher safe. The polyurethane foil turns yellowish and hardens after prolonged exposure to sun light (UV). If the underlying color of the tray is a light color, the yellowish look can be very noticeable and unattractive.

Finally, if the foil hardens, it can be easily peeled from the underlying surface, which is also undesirable. To the extent the tray is washed in a dishwasher, the polyurethane foil hardens, which leads to easy peeling. Further the hot water tends to invade the bond between the foil and underlying surface, which loosens the foil and ultimately reduces the life of the tray.

Because of the problems inherent in non-slip polyurethane surfaces, tray manufacturers have developed non-slip rubber surfaces for polyester trays. In some cases, rubber is separately molded and then attached to polyester tray surface by compression molding. In other cases a single step process is used. In either case, the rubber surfaces on these trays retain non-slip characteristics even when wet and avoid the staining and peeling problems with polyurethane foils. These trays, however, are heavy and expensive to produce.

Thus, there is a need for a non-slip article, such as a food tray, that is brightly colored, inexpensive to produce, stable, stain resistant, UV and dishwasher safe, and possesses a non-slip surface even under wet conditions. Unlike the rubber surface polyester trays currently available in the market, the non-slip articles such as food trays described herein are lighter, more durable, and have a glass like bottom exterior surface. Another advantage of articles described herein is that they can be manufactured in several colors, including bright colors and multiple colors. For example, articles such as food trays having a two or more colors can be produced using the materials and methods described herein.

### DETAILED DESCRIPTION

The materials, articles and methods described herein may be understood more readily by reference to the following detailed description of preferred embodiments of the invention and the Examples included herein.

It must be noted that, as used in the specification and the appended claims, the singular forms “a,” “an,” and “the” include plural referents unless the context clearly dictates otherwise. Thus, for example, reference to “an additive” includes mixtures of additives.

Ranges are often expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

A weight part of a component, unless specifically stated to the contrary, is based on the weight or mass of one component relative to the weight or mass of a second component. The weight or mass can be expressed in grams, pounds, or any other acceptable unit of mass.

Throughout this application, where publications are referenced, the disclosures of these publications in their entireties are hereby incorporated by reference into this application in order to more fully describe the state of the art to which this invention pertains.

Described herein are materials for making non-slip articles. In one aspect, the material comprises
(a) a first layer comprising a substrate, wherein the first layer has a first surface and a second surface, wherein the substrate is impregnated with a first resin;
(b) a second layer comprising paper, wherein the second layer has a first surface and second surface, wherein the first surface of the second layer is adjacent to the second layer of the first layer, wherein the paper is impregnated with a second resin;
(c) a third layer comprising a fabric, wherein the third layer has a first surface and a second surface, wherein the first surface of the third layer is adjacent to the second surface of the second layer, wherein the fabric is impregnated with a third resin; and
(d) a fourth layer comprising rubber, wherein the fourth layer has a first surface and second surface, wherein the first surface of the fourth layer is adjacent to the second surface of the third layer.

In another aspect, the material comprises
(a) a first layer comprising a substrate, wherein the first layer has a first surface and second surface, wherein the substrate is impregnated with a first resin;
(b) a second layer comprising a fabric, wherein the second layer has a first surface and a second surface, wherein the first surface of the second layer is adjacent to the second surface of the first layer, wherein the fabric is impregnated with a second resin; and
(c) a third layer comprising at least two pieces of rubber having different colors, wherein the third layer has a first surface and second surface, wherein the first surface of the third layer is adjacent to the second surface of the second layer.

Any of the components described below can be used for making any of the materials and articles described herein.

In general, the substrate can be any material that has a surface capable of receiving one or more layers of material. In one aspect, the substrate comprises wood, veneer, overlay, or decor paper. When the substrate is decor paper, the paper can be white or possess one or more colors. Additionally, the decor paper can have print thereon such as words or drawings. Any decor paper known in the art can be used as the substrate. For example, decor paper manufactured by Lamigraf, Sueddekor, and Schattdekor can be used as the substrate. Depending upon the article that is produced, variables to consider when selecting the substrate include the absorption, porosity, wet strength, and smoothness of the substrate.

The paper layer used in the materials described herein can be any paper known in the art. The paper used herein should display good wet strength. Any of the paper products disclosed in U.S. Pat. No. 6,040,044, which is incorporated by reference in its entirety, can be used herein. Examples of paper useful for producing the materials and article described herein include, but are not limited to, titanium paper, linter paper, cardboard, plasterboard paper, high-grade paper, coated paper, art paper, vegetable parchment, glassine paper, animal parchment, paraffin paper, Japanese paper, craft paper, or a combination thereof. Two or more layers of the paper can be used to produce the material. By varying the number of layers of paper, it is possible to change the thickness of the material and ultimately the article produced by the material. In one aspect, when craft paper is selected as the paper, it has a volatility before and after impregnation with the resin of 5% to 8%, 5.5% to 7.5%, or 6.0% to 7.0% of the combined paper and resin weight.

The fabric used to produce the materials and articles described herein can be woven or non-woven materials. Any of the fabrics disclosed in U.S. Pat. No. 6,040,044 and European Published Application No. 0549948, which are incorporated by reference in their entireties, can be used to produce the materials and articles described herein. Examples of fabrics include, but are not limited to, glass fiber, asbestos, potassium titanate fiber, alumina fiber, silica fiber, carbon fiber, a polyester, 100% cotton, a blend of cotton and polyester, or a combination thereof.

The rubber in the fourth layer can be any natural or synthetic rubber known in the art. The rubber used to produce the materials and articles described herein should possess good heat stability, resistance to staining, and non-slip properties. Additionally, rubber that can be produced in different colors is also useful.

Any of the rubber materials disclosed in U.S. Pat. Nos. 6,620,875 and 6,617,383, which are incorporated by reference in their entireties, can be used to produce the materials and articles described herein. In one aspect, diene rubbers such as, for example, 1,3-butadiene; 2-methyl-1,3-butadiene; 1,3-pentadiene; 2,3-dimethyl-1,3-butadiene; and the like, as well as copolymers of such conjugated dienes with monomers such as, for example, styrene, alpha-methylstyrene, acetylene (e.g., vinyl acetylene, acrylonitrile, methacrylonitrile, methyl acrylate, ethyl acrylate, methyl methacrylate, ethyl methacrylate, vinyl acetate, and the like) can be used. Examples of unsaturated rubbers include, but are not limited to, natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly (acrylonitrile-butadiene), or ethylene-propylene-diene copolymer (EPDM).

In another aspect, the rubber is an olefin-based rubber, a maleic acid modified ethylene propylene rubber, an isobutylene and aromatic vinyl or diene-based monomer copolymer, an acryl rubber, a halogen-based rubber (e.g., a bromide of isobutylene p-methylstyrene copolymer, a chioroprene rubber, a hydrin rubber, a chlorosulfonated polyethylene), a chlorinated polyethylene, a maleic acid modified chlorinated polyethylene, a silicone rubber (e.g., methylvinyl silicone rubber, dimethyl silicone rubber, and methylphenylvinyl silicone rubber), a sulfur-containing rubber (e.g., polysulfide rubber), a fluororubber (e.g., vinylidene fluoride based rubber, fluorine-containing vinyl ether-based rubber, tetrafluoroethylene-propylene-based rubber, fluorine-containing silicone-based rubber, and fluorine-containing phosphagen-based rubber), a thermoplastic elastomer (e.g., styrene-based elastomer, olefin-based elastomer, ester-based elastomer, urethane-based elastomer, polyamide-based elastomer).

The rubber can optionally contain fillers and additives known in the art. For example, the rubber can contain inorganic fillers such as chalk, kaolin, silica, or calcium carbonate.

The materials described herein are formed with the use of resins that are impregnated within the particular layer. The term “impregnate” includes from (1) the mere surface coverage of the layer with the resin to (2) complete saturation of the layer with the resin. The degree of impreganation will vary depending upon the substrate, paper, and fabric that are selected, particularly the porosity of the material. The impregnation of the substrate, paper, and fabric can be performed using techniques known in the art, including dipping, soaking, or spraying the resin onto these materials. Alternatively, the substrate, paper, and/or fabric can be purchased already impregnated with the resin.

The amount of resin that is impregnated will vary depending upon the substrate, paper, and fabric. In one aspect, when the substrate is decor paper, the amount of resin impregnated into the decor paper is from 90% to 140%, 100% to 115%, or 110% by weight of the decor paper. In another aspect, the amount of resin impregnated into the fabric is from 70% to 110%, 80% to 100%, or 80% to 90% by weight of the fabric. In a further aspect, when the paper is craft paper, the amount of resin impregnated into the craft paper is from 30% to 40%, 30% to 36%, 32% to 38%, 32% to 34%, or 33% by weight of the craft paper.

The resin imparts several advantages to the materials and articles described herein. For example, the resin provides better adherence between the layers in the material. In comparison to polyester, melamine surface is much harder and therefore scratch and stain resistant. In addition, when the article is a food tray, the hard surface produced by the resin is safer because food trays are classified by the National Sanitary Foundation as Class 2 (occasional food contact). Finally, certain resins such as melamine can be used for Class 1 direct food contact, which is not the case for polyester.

Any resin known in the art for adhering two layers can be used herein. Any of the resins disclosed in U.S. Pat. Nos. 5,952,447, 6,040,044, and 6,534,150 B1, which are incorporated by reference in their entireties, can be used to produce the materials and articles described herein. Examples of resins include, but are not limited to, melamine resin, phenolic resin, urea resin, or a combination thereof. In one aspect, the substrate is impregnated with melamine resin. In another aspect, the paper is impregnated with phenolic resin. In a further aspect, the fabric is impregnated with melamine resin.

In one aspect, the material is produced by stacking each layer sequentially so that the layers are adjacent to one another. The term “adjacent” as referred to herein is defined as two layers that are in physical contact with one another. The contact between the two layers can occur exclusively at the surface of the two layers. Alternatively, the term “adjacent” also refers to one layer permeating into the other layer. For example, depending upon the selection of the rubber, fabric, and resin, the rubber material described above can penetrate the fabric surface. The term “adjacent” also includes two layers joined by a thin layer of resin between the two layers. Depending upon the resin, substrate, paper, fabric, and rubber selected, the different layers may adhere to one another via the formation of new chemical bonds. Alternatively, the resin can act as an adhesive that holds the two layers together via a physical interaction. The term “adjacent” also refers to any two layers described herein that are separated by another layer. For example, a second substrate can be stacked on top of the paper layer followed by stacking the fabric on the second substrate.

In one aspect, the substrate is cut to a particular shape and size depending upon the article that is to be produced. The substrate can be impregnated prior to or after the sizing of the substrate. Next, one or more layers of paper impregnated with the resin are stacked on the substrate. The number of layers of paper that are to be added will vary depending upon the thickness of the article that is produced. In one aspect, a second substrate can be stacked on the paper, followed by the addition of one or more layers of paper applied to the top of the second substrate. In another aspect, the second substrate can be stacked on the final layer of the paper. After the stacking of the substrate and paper, one or more layers of fabric impregnated with resin are stacked on top of the paper or substrate. Finally, the rubber material is applied on top of the fabric. In one aspect, the rubber material can be a sheet of rubber having one color. In another aspect, the rubber comprises two or more pieces of rubber, where each piece has a different color. Here, the rubber pieces are cut so that when they are applied to the exposed layer of fabric, there are no gaps between the different pieces. Alternatively, several pieces of rubber can be cut, where one or more pieces have the same color.

In another aspect, the fabric is directly stacked on the substrate, wherein the fabric and substrate are impregnated with a resin. A sheet of rubber is then applied to the exposed surface of the fabric. In one aspect, the rubber can be one piece of rubber having one color one or multiple pieces of rubber, where each piece of rubber can have a different color.

Not wishing to be bound by theory, it is believed that the fabric creates a stronger bond (i.e., better adhesion) between the rubber and the substrate or paper. It is this bond that ultimately creates a harder, more durable article.

In one aspect, once the stacked material is produced, it is placed in a mold of a particular shape and size. In an alternate aspect, the substrate and paper can be molded into the desired article followed by the application of the fabric and rubber to the mold and heating the resultant article to set the fabric/rubber layer. Techniques known in the art can be used to mold any of the materials described herein to produce the article. In one aspect, the material is molded by heat compression molding or a similar process. When compression molding is used to produce the shaped article, the temperature, pressure, and duration of the molding step are dependent upon one another. In one aspect, the molding step is conducted at a temperature of from 130° C. to 190° C., 140° C. to 180° C., or 145° C. to 170° C. In another aspect, the pressure at which the molding step occurs is from 50 kg/cm² to 150 kg/cm², 60 kg/cm² to 140 kg/cm², 70 kg/cm² to 130 kg/cm², or 75 kg/cm² to 120 kg/cm². In a further aspect, the molding step is conducted from 1 minute to 10 minutes, 2 minutes to 9 minutes, 2 minutes to 8 minutes, 2 minutes to 6 minutes, 3 minutes to 5 minutes, or 3.5 minutes. After the mold has been produced, additional steps such as sanding the edges and comers of the article can be performed in order to produce a smooth article.

Any of the materials described herein can be used to produce an article where it is desirable to have non-slip properties. In one aspect, the article is made solely of the materials described herein. For example, any of the materials described herein can be molded into a food tray. In another aspect, the materials described herein can be applied to another article or device. For example, the materials can be applied to the top of a beverage cart to prevent the beverages from slipping off the cart.

### EXAMPLES

The following Examples are set forth so as to provide those of ordinary skill in the art with a complete disclosure and description of how the materials, articles, and methods claimed herein are made, performed and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be taken into account. Unless indicated otherwise, parts are parts by weight, temperature is in ° C. or is at room temperature, and pressure is at or near atmospheric.

### Example 1

A heated mold and a pressing machine were used in the production of a rubberform tray. The mold was heated to 150° C. The pressing machine has the capability of applying an average pressure of 100 kg per square centimeter. The size of the tray will determine the amount of pressure to be applied. The pressure is calculated using the following formula
pressure=tray length (cm)×tray width (cm)×100 kg

The materials used in the preparation of the tray are: (1) one sheet of decor paper impregnated with melamine resin; (2) several sheets of craft paper impregnated with phenolic resin; (3) one sheet of 100% cotton impregnated with melamine resin; and (4) a sheet of EPDM rubber. The materials were stacked in the order recited. The number of sheets of craft paper determined the thickness of the tray.

The press was opened and the stack was carefully placed in the mold. The press was closed, and the total cycle time was three minutes. After the first 15 seconds, the press was vented by opening and immediately closing the press so that the existing vapor was swept away. After the operation was finished, the tray was cooled on a flat surface under 3-5 kg of pressure so that it remained stable. The tray was sanded so that the edges and comers were smooth.

After the production of the tray, the following tests were performed to determine several properties of the resultant tray.
Heat test: Trays were put into a ventilated heated oven and the following characteristics were monitored: (1) existence of bubbles; (2) color change; (3) possible delamination; (4) stain visibility; (5) odor; and (6) change in non-slip characteristics.
Boil test: Trays were boiled for 24 hours and the visual characteristics listed above were monitored.
Non-slip test: The degree of the angle that the tray remains non-slip was measured.
Non-slip test wet: The degree of the angle that the tray remains non-slip in wet conditions was measured.
Delamination test: The effort to remove the rubber surface completely away from the tray was measured.
Stain test: 17.5 gram industrial dishwashing detergent per one liter of 0 degree hardness water was heated up to 80° C. Part of the rubber surface of the tray was sanded with a 320 number sand paper 10 times to the left and 10 times to the right. The tray was placed into the dishwashing detergent mixture for three hours. Afterwards, coffee, tea, cola, wine, beer, ketchup, vinegar, oil, mustard, and fruit juice were placed on the sanded and non sanded surfaces of the tray. After 24 hours, the tray was cleaned and any visible stains present on the tray were observed and noted.
UV lamp aging test: The tray was placed under an UV lamp for 12 hours to monitor any color change.
Shore hardness: The shore hardness of the rubber surface of the tray was measured with a shoremeter. (Shore is a unit to measure the hardness of soft materials like rubber. A shoremeter is a device used to measure the hardness of a rubber surface.
Barcol impressor hardness: The hardness of the bottom side of the tray was measured with a barcol impressor measuring device. A barcol impressor is a device used to measure the hardness of hard surfaces like metals, glass, porcelain etc. For glass, the barcol impression hardness is 100.

The results are shown in Tables 1 and 2.

TABLE 1

| | RESULTS | | | | | | |
|---|---|---|---|---|---|---|---|
| Test | Measured | | Color | | | | Non-Slip |
| Name | Degree | Bubbles | Change | Delamination | Stain | Smell | Characteristic |
| Heated | 30° C. | No | No | No | No | No | No Change |
| Oven | 50° C. | No | No | No | No | No | No Change |
| | 70° C. | No | No | No | No | No | No Change |
| | 90° C. | No | No | No | No | No | No Change |
| | 100° C. | No | No | No | No | No | No Change |
| | 120° C. | No | No | No | No | Yes | No Change |
| Boil Test | 100° C. | No | No | No | No | No | No Change |
| Water, | | | | | | | |
| 100° C. 24 | | | | | | | |
| Hours | | | | | | | |

TABLE 2

| Test Name | Test Results |
|---|---|
| Non-Slip Degree Dry | 45° |
| Non-Slip Degree Wet | 40° |
| Delamination | Negative |
| Stain Test | No Stains Visible |
| Shore Hardness Top | 55 |
| Barcol Impressor Bottom | 61 |
| UV-Lamp Aging Test | No Difference |

The materials, articles, and methods have been described in detail with particular reference to preferred embodiments thereof, but it will be understood that variations and modifications can be affected without departing from the scope and spirit of the invention.

1. A material comprising
(a) a first layer comprising a substrate, wherein the first layer has a first surface and a second surface, wherein the substrate is impregnated with a first resin;
(b) a second layer comprising paper, wherein the second layer has a first surface and second surface, wherein the first surface of the second layer is adjacent to the second layer of the first layer, wherein the paper is impregnated with a second resin;
(c) a third layer comprising a fabric, wherein the third layer has a first surface and a second surface, wherein the first surface of the third layer is adjacent to the second surface of the second layer, wherein the fabric is impregnated with a third resin; and
(d) a fourth layer comprising rubber, wherein the fourth layer has a first surface and second surface, wherein the first surface of the fourth layer is adjacent to the second surface of the third layer.

2. The material of claim 1, wherein the substrate comprises wood, veneer, overlay, or decor paper.

3. The material of claim 1, wherein the substrate is decor paper.

4. The material of claim 3, wherein the décor paper is white.

5. The material of claim 3, wherein the décor paper is colored.

6. The material of claim 1, wherein the paper comprises titanium paper, linter paper, cardboard, plasterboard paper, high-grade paper, coated paper, art paper, vegetable parchment, glassine paper, animal parchment, paraffin paper, Japanese paper, or a combination thereof.

7. The material of claim 1, wherein the paper is craft paper.

8. The material of claim 1, wherein the second layer comprises two or more layers of paper.

9. The material of claim 1, wherein the fabric is woven.

10. The material of claim 1, wherein the fabric is non-woven.

11. The material of claim 1, wherein the fabric comprises glass fiber, asbestos, potassium titanate fiber, alumina fiber, silica fiber, carbon fiber, a polyester, or a combination thereof.

12. The material of claim 1, wherein the fabric comprises cotton or a blend of cotton and polyester.

13. The material of claim 1, wherein the rubber comprises a synthetic rubber.

14. The material of claim 1, wherein the rubber comprises a natural rubber.

15. The method of claim 1, wherein the fourth layer comprises at least two pieces of rubber having different colors.

16. The material of claim 1, wherein the rubber comprises a diene-based rubber or its hydrates, an olefin-based rubber, a maleic acid modified ethylene propylene rubber, a copolymer of isobutylene and aromatic vinyl or diene-based monomer, an acryl rubber, a halogen-based rubber, a chloroprene rubber, a hydrin rubber, a chlorosulfonated polyethylene, a chlorinated polyethylene, a maleic acid modified chlorinated polyethylene, a silicone rubber, a sulfur-containing rubber, a fluororubber, or a combination thereof.

17. The material of claim 1, wherein the rubber comprises an ethylene-propylene-diene copolymer.

18. The material of claim 1, wherein the first resin, second resin, and third resin comprises melamine resin, phenolic resin, urea resin, or a combination thereof.

19. The material of claim 1, wherein the first resin comprises melamine resin.

20. The material of claim 1, wherein the second resin comprises phenolic resin.

21. The material of claim 1, wherein the third resin comprises melamine resin.

22. The material of claim 1, wherein the substrate comprises decor paper, the second layer paper comprises craft paper, the fabric comprises cotton, the rubber comprises an ethylene-propylene-diene copolymer, the first resin comprises a melamine resin, the second resin comprises a phenolic resin, and the third resin comprises a melamine resin.

23. The material of claim 1, wherein the first surface of the second layer is in contact with the second surface of the first layer, the first surface of the third layer is in contact with the second surface of the second layer, the first surface of the third layer is in contact with the second surface of the fourth layer.

24. A method for making an article, comprising molding the material of claim 1 into the desired article.

25. The method of claim 24, wherein the molding step comprises compression molding.

26. The method of claim 24, wherein the molding step is conducted at a temperature of from 130° C. to 190° C.

27. The method of claim 24, wherein the molding step is conducted at a temperature of from 145° C. to 170° C.

28. The method of claim 24, wherein the molding step is conducted at a pressure of from 50 kg/cm² to 150 kg/cm².

29. The method of claim 24, wherein the molding step is conducted at a pressure of from 75 kg/cm² to 120 kg/cm².

30. The method of claim 24, wherein the molding step is conducted from 2 minutes to 6 minutes.

31. The method of claim 24, wherein the molding step is conducted from 3 minutes to 3.5 minutes.

32. An article produced by the method of claim 24.

33. The article of claim 32, wherein the article is a food tray.

34. An article comprising the material of claim 1.

35. An article consisting of the material of claim 1.

36. An article consisting essentially of the material of claim 1.

37. The article of claim 34, wherein the article is a food tray.

38. A material comprising
(a) a first layer comprising a substrate, wherein the first layer has a first surface and second surface; wherein the substrate is impregnated with a first resin;
(b) a second layer comprising a fabric, wherein the second layer has a first surface and a second surface, wherein the first surface of the second layer is adjacent to the second surface of the first layer, wherein the fabric is impregnated with a second resin; and
(c) a third layer comprising at least two pieces of rubber having different colors, wherein the third layer has a first surface and second surface, wherein the first surface of the third layer is adjacent to the second surface of the second layer.

39. The material of claim 38, wherein the substrate comprises a polyester, the fabric comprises cotton, the rubber comprises an ethylene-propylene-diene copolymer, and the first and second resins comprise a melamine resin.

40. An article comprising the material of claim 38.

41. The article of claim 40, wherein the article is a food tray.
